(19) United States
(12) Patent Application Publication
(10) Pub. No.: US 2026/0030942 A1
(43) Pub. Date: Jan. 29, 2026

(54) ENTRY TERMINAL DEVICE, ENTRY MANAGEMENT SYSTEM, AND ENTRY MANAGEMENT METHOD

(71) Applicants: HYUNDAI MOTOR COMPANY, Seoul (KR); KIA CORPORATION, Seoul (KR); HANVIT SI. INC., Seoul (KR)

(72) Inventors: Tae Gwon Han, Hwaseong-si (KR); Won Jun Lee, Hwaseong-si (KR); Yong Jun Lee, Hwaseong-si (KR); Dong Hae Lee, Hwaseong-si (KR); Hyun Yong Cha, Hwaseong-si (KR); Yung Lee, Hwaseong-si (KR); Tae Gyun Kwon, Yongin-si (KR)

(73) Assignees: HYUNDAI MOTOR COMPANY, Seoul (KR); KIA CORPORATION, Seoul (KR); HANVIT SI. INC., Seoul (KR)

(21) Appl. No.: 18/976,774

(22) Filed: Dec. 11, 2024

(30) Foreign Application Priority Data
Jul. 24, 2024 (KR) 10-2024-0097889

(51) Int. Cl. G07C 9/27; G06F 3/147

(52) U.S. Cl. CPC G07C 9/27; G06F 3/147

(57) ABSTRACT

An entry terminal device, an entry management system, and an entry management method are provided. The entry terminal device includes an e-paper panel configured to display entry information of the visitor and a Bluetooth low energy (BLE) communication unit configured to transmit and receive beacon signals to and from a plurality of BLE access points (APs). The entry terminal device also includes at least one processor and at least one memory that stores at least one program executable by the at least one processor. The processor is configured to process the entry information received from a visitor management server through a first BLE AP among the plurality of BLE APs to be displayed on the e-paper panel.

### CROSS-REFERENCE TO RELATED APPLICATION

This application claims the benefit of and priority to Korean Patent Application No. 10-2024-0097889, filed on Jul. 24, 2024, the entire contents of which are hereby incorporated herein by reference.

### BACKGROUND

### 1. Field of the Invention

The present disclosure relates to an entry terminal device, an entry management system, and an entry management method, and more particularly, to an entry terminal device, an entry management system, and an entry management method, that are capable of determining a location of the entry terminal device in real time and changing a background color of the entry terminal device according to a mode.

### 2. Discussion of Related Art

Existing entry management systems manage the entry of visitors using entry passes enabled with a near field communication (NFC) technology. However, in the existing entry management systems, since entry information of a visitor is not displayed on an entry pass, when an emergency situation occurs, it is difficult to check an identity of the visitor or to determine a current location of the visitor.

In addition, when a visitor enters an unauthorized area to which he or she is not permitted to enter in advance, it is difficult to immediately identify which visitor among a plurality of visitors has entered the unauthorized area.

In addition, even when a visitor has an entry pass, there is a limit to an administrator's ability to check information about an authorized area and unauthorized area for the visitor from the entry pass.

In addition, in general, an entry pass is provided to a visitor by inserting an NFC card into a case for an entry pass. In this case, there is an inconvenience that the administrator should manually perform a task of mapping an NFC card and a visitor every time the NFC card is changed.

### SUMMARY

Embodiments of the present disclosure provide an entry terminal device, an entry management system, and an entry management method, that are capable of determining a location of the entry terminal device in real time, checking information of a visitor located in an unauthorized area in real time, and identifying a state of the entry terminal device using a background color of the entry terminal device.

The technical objectives to be achieved in the present disclosure are not limited to the technical problems mentioned above. Other technical objectives that are not mentioned herein may be more clearly understood by those having ordinary skill in the art to which the present disclosure pertains from the description below.

According to an aspect of the present disclosure, an entry terminal device for entry management of a visitor is provided. The entry terminal device includes an e-paper panel that displays entry information of the visitor, a Bluetooth low energy (BLE) communication unit that transmits and receives beacon signals to and from a plurality of BLE access points (Aps), at least one processor, and at least one memory. The at least one memory that stores at least one program that, when executed by the at least one processor, causes the at least one processor to process the entry information received from a visitor management server through a first BLE AP among the plurality of BLE APs to be displayed on the e-paper panel.

The visitor management server may request the first BLE AP to perform pairing with the BLE communication unit, and when the pairing is performed, the entry information may be transmitted to the BLE communication unit through the paired first BLE AP.

The processor may process the entry information received from the visitor management server through the paired first BLE AP to be displayed on the e-paper panel, switch a state of the entry terminal device to an active state, and display a background color corresponding to a basic mode on the e-paper panel.

When the entry terminal device is located in an unauthorized area or an emergency signal is received from the BLE communication unit, the visitor management server may transmit a control signal for instructing a change in the background color, and the processor may process the background color of the e-paper panel to be changed to a color preset in the received control signal such that the color is identifiable by another person.

When the pairing is performed, the visitor management server may further transmit a plurality of pieces of background data to be displayed on the entry terminal device to the entry terminal device, and the plurality of pieces of background data may include a background color set differently for each control signal transmitted from the visitor management server.

The entry terminal device may further include a sensor that transmits an infrared signal to calculate a distance between an object and a front surface of the e-paper panel on which the entry information is displayed, and the processor may determine whether the front surface is in a blocking state using the calculated distance, and control the BLE communication unit to transmit a result of the determination to the visitor management server when the front surface is in the blocking state to the visitor management server, and when the result of the determination is received, the visitor management server may transmit a control signal for outputting a warning sound to the BLE communication unit.

The plurality of BLE APs may transmit the beacon signal received from the BLE communication unit to the visitor management server, the visitor management server may manage a location of the entry terminal device based on the beacon signal received through at least one of the plurality of BLE APs and pre-stored entry mapping information, and the entry mapping information may be information in which identification information of the entry terminal device and the entry information of the visitor registered in advance are mapped based on identification information of the visitor input by the visitor when the entry terminal device is received.

The identification information of the entry terminal device may include at least one of a media access control (MAC) address of a beacon and an identification number of a near field communication (NFC) module included in the entry terminal device, and the entry information may include at least one of a name, a company name, a face photo, and a date and time of visit of the visitor, and an authorized area where the visitor is permitted to visit.

The entry terminal device may further include a near field communication (NFC) unit that performs entry authentication through NFC communication.

The e-paper panel may further display a facial image of the visitor, and the facial image of the visitor may be generated by an entry terminal issuing apparatus that issues the entry terminal device.

According to another aspect of the present disclosure, an entry management system is provided. The entry management system includes an entry terminal device issued to a visitor, an entry terminal issuing apparatus that issues the entry terminal device to the visitor when identification information of the visitor is input, and a visitor management server that stores entry mapping information in which identification information of the entry terminal device and entry information of the visitor registered in advance are mapped based on the identification information of the visitor. The entry management system also includes a plurality of Bluetooth low energy access points (BLE APs) configured to communicate with the entry terminal device and the visitor management server. The entry terminal device is configured to display the entry information of the visitor received from the visitor management server through a first BLE AP among the plurality of BLE APs on an e-paper panel.

The visitor management server may request the first BLE AP to perform pairing with the entry terminal device, and when the pairing is performed, the entry information of the visitor may be transmitted to the entry terminal device through the paired first BLE AP.

The entry terminal device may display the entry information received from the visitor management server through the paired first BLE AP on the e-paper panel, switch a state thereof to an active state, and display a background color corresponding to a basic mode on the e-paper panel.

The visitor management server may transmit a control signal for instructing a change in the background color when the entry terminal device is located in an unauthorized area or an emergency signal is received from the entry terminal device, and the entry terminal device may process the background color of the e-paper panel to be changed to a color preset in the received control signal such that the color is identifiable by another person.

When the pairing is performed, the visitor management server may further transmit a plurality of pieces of background data to be displayed on the entry terminal device to the entry terminal device, and the plurality of pieces of background data may include a background color set differently for each control signal transmitted from the visitor management server to guide a state of the entry terminal device.

When it is determined that a front surface of the e-paper panel on which the entry information is displayed is in a blocking state, the entry terminal device may process a result of the determination to be transmitted to the visitor management server through at least one of the plurality of BLE APs, and when the result of the determination is received, the visitor management server may transmit a control signal for outputting a warning sound to the entry terminal device.

The plurality of BLE APs may transmit beacon signals received from the entry terminal device to the visitor management server, and the visitor management server may manage a location of the entry terminal device based on the beacon signals received from the plurality of BLE APs and the stored entry mapping information.

The entry terminal issuing apparatus may photograph a face of the visitor to generate a facial image and then issue the entry terminal device, and the generated facial image may be transmitted to the entry terminal device and displayed on the e-paper panel.

According to still another aspect of the present disclosure, an entry management method is provided. The entry management method includes, when identification information of a visitor is input. The entry management method also includes issuing, by an entry terminal issuing apparatus, an entry terminal device to the visitor. The entry management method further includes storing, by a visitor management server, entry mapping information in which identification information of the entry terminal device and entry information of the visitor registered in advance are mapped based on the identification information of the visitor. The entry management method additionally includes displaying, by the entry terminal device, the entry information of the visitor received from the visitor management server through a first BLE AP among a plurality of BLE APs on an e-paper panel, where the plurality of BLE APs communicate with the entry terminal device and the visitor management server.

In the displaying of the entry information of the visitor on the e-paper panel, the entry terminal device may display the entry information received from the visitor management server through a paired first BLE AP among the plurality of BLE APs on the e-paper panel, switch to an active state, and display a background color corresponding to a basic mode on the e-paper panel.

When the entry terminal device is located in an unauthorized area or an emergency signal is received from the entry terminal device, the entry management method may further include transmitting, by the visitor management server, a control signal for instructing a change in the background color, and processing, by the entry terminal device, the background color of the e-paper panel to be changed to a color preset in the received control signal such that the color is identifiable by another person.

The entry management method may further include transmitting, by the visitor management server, a plurality of pieces of background data to be displayed on the entry terminal device together with the entry information to the entry terminal device through the paired first BLE AP, and the plurality of pieces of background data may include a background color set differently for each control signal transmitted from the visitor management server to guide a state of the entry terminal device.

The features briefly summarized above for the present disclosure are merely illustrative aspects of the present disclosure described below, and do not limit the scope of the present disclosure.

### BRIEF DESCRIPTION OF THE DRAWINGS

The above and other objects, features, and advantages of the present disclosure should become more apparent to those having ordinary skill in the art from the following description taken in conjunction with the accompanying drawings, in which:

FIG. 1 is a conceptual diagram of an entry management system for visitor management, according to an embodiment of the present disclosure;

FIG. 2 is a diagram showing a configuration of the entry management system for visitor management, according to an embodiment of the present disclosure;

FIG. 3 is a diagram for describing a visit operation in an operation of the entry management system, according to an embodiment of the present disclosure;

FIG. 4 is a diagram for describing a return operation in the operation of the entry management system, according to an embodiment of the present disclosure;

FIG. 5 is a block diagram showing an entry terminal device, according to an embodiment of the present disclosure;

FIG. 6 is a diagram showing the front and rear surfaces of the entry terminal device, according to an embodiment of the present disclosure;

FIG. 7 is a diagram showing a background color related to a state of the entry terminal device, according to an embodiment of the present disclosure;

FIG. 8 is a flowchart illustrating a method of issuing an entry terminal device in an entry management method for visitor management, according to an embodiment of the present disclosure;

FIG. 9 is a flowchart for describing an entry management method when the entry terminal device is located in an unauthorized area in the entry management method for visitor management, according to an embodiment of the present disclosure;

FIG. 10 is a flowchart for describing an entry management method when an entry terminal device is in an emergency situation in the entry management method for visitor management, according to an embodiment of the present disclosure; and

FIG. 11 is a flowchart for describing an entry management method when an entry terminal device is in a blocking state in the entry management method for visitor management, according to an embodiment of the present disclosure.

### DETAILED DESCRIPTION

Hereinafter, with reference to the accompanying drawings, embodiments of the present disclosure are described in detail to enable those skilled in the art to practice the embodiments. However, the present disclosure may be implemented in many different forms and is not limited to the embodiments described herein.

In describing embodiments of the present disclosure, when it was determined that a detailed description of a known configuration or function may obscure the gist of the present disclosure, the detailed description thereof has been omitted. In addition, in the drawings, parts that are not related to the description of the present disclosure are omitted, and similar parts are given similar reference numerals.

In the present disclosure, when a component is said to be “connected,” “joined,” “coupled,” or the like, to another component, this may include not only a direct connection relationship between the component and the other component, but also an indirect connection relationship where one or more other components exist in between. In addition, when a component is said to “include,” “comprise,” “have,” or the like, another component, this does not mean that other components are excluded. Rather, other components may be further included unless specifically stated to the contrary.

In the present disclosure, terms such as “first,” “second,” etc. are used only for the purpose of distinguishing one component from other components. These terms do not limit the order or importance between components unless specifically mentioned. Accordingly, within the scope of the present disclosure, a first component in an embodiment may be referred to as a second component in another embodiment, and similarly, a second component in an embodiment may be referred to as a first component in another embodiment.

In the present disclosure, describing components as distinct from each other is intended to clearly describe their respective features, and does not necessarily mean that the components are separated. For example, a plurality of components may be integrated to form a single hardware or software unit, or a single component may be distributed to form a plurality of hardware or software units. Accordingly, even when not specifically mentioned, such integrated or distributed embodiments are also included in the scope of the present disclosure.

In the present disclosure, components described in various embodiments are not necessarily essential components, and some of the components may be optional components. Accordingly, embodiments configured with a subset of components described in an embodiment are also included in the scope of the present disclosure. In addition, embodiments that include other components in addition to the components described in various embodiments are also included in the scope of the present disclosure.

In the present disclosure, phrases such as “A or B,” “at least one of A and B,” “at least one of A or B,” “A, B or C,” “at least one of A, B and C,” and “at least one of A, B, C or a combination thereof” may include any one of the items listed together with the corresponding phrase among the phrases, or all possible combinations thereof.

The advantages and features of the present disclosure and methods for achieving them should become more clear to one of ordinary skill in the art by referring to embodiments described in detail below along with reference to the accompanying drawings. However, the present disclosure is not limited to the embodiments presented below and may be implemented in various different forms. The described embodiments are merely provided to ensure that the present disclosure is complete and to fully inform those having ordinary skill in the art to which the present disclosure pertains of the scope of the present disclosure.

In addition, in the present specification, the terms “module,” “part,” “device,” “server,” etc. may be intended to refer to hardware or a functional or structural combination of software driven by corresponding hardware or for driving hardware. For example, hardware herein may be a data processing device including a central processing unit (CPU) or another processor. In addition, software driven by hardware may refer to a running process, an object, an executable, a thread of execution, a program, etc.

In addition, in the present specification, a “system” or a “server” may include one or more computing devices and may be provided in a local or cloud form, but is not limited thereto.

When a component, device, unit, element, or the like of the present disclosure is described as having a purpose or performing an operation, function, or the like, the component, device, or element should be considered herein as being “configured to” meet that purpose or perform that operation or function.

Hereinafter, various embodiments of the present disclosure are described in detail with reference to the accompanying drawings.

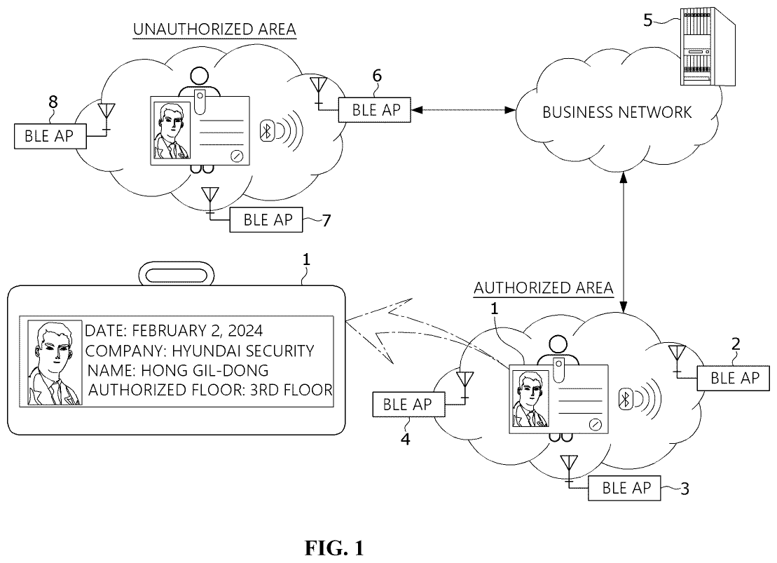

FIG. 1 is a conceptual diagram of an entry management system for visitor management, according to an embodiment of the present disclosure.

Referring to FIG. 1, a visitor wearing an entry terminal device 1 moves in an authorized area that was registered in advance. The entry terminal device 1 may communicate with a business network through a plurality of Bluetooth low energy access points (BLE APs) 2, 3, and 4. The business network includes a visitor management server 5. When the visitor moves to an unauthorized area that has not been registered in advance, the visitor management server 5 may determine a location of the entry terminal device 1 based on beacon signals received from the entry terminal device 1 by a plurality of BLE APs 2, 3, and 4 provided in the unauthorized area.

The visitor management server 5 may transmit a control signal to the entry terminal device 1 located in the unauthorized area to process the entry terminal device 1 to output a warning sound and change a background color thereof.

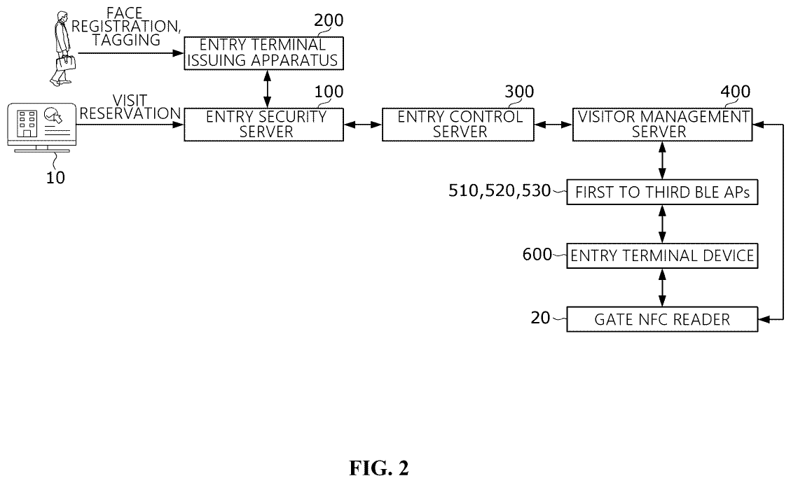

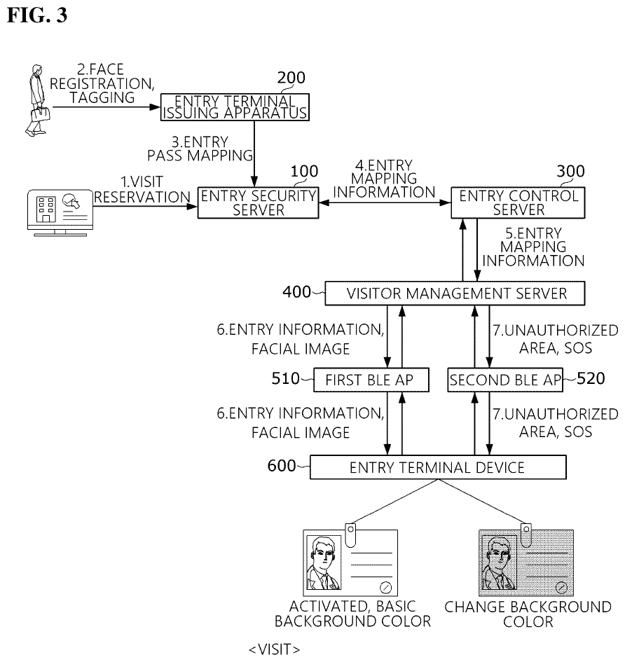

FIG. 2 is a diagram illustrating a configuration of an entry management system for visitor management, according to an embodiment of the present disclosure. FIG. 3 is a diagram for describing a visit operation in an operation of the entry management system according to an embodiment of the present disclosure.

Referring to FIGS. 2 and 3, the entry management system for visitor management according to an embodiment of the present disclosure may include an entry security server 100, an entry terminal issuing apparatus 200, an entry control server 300, a visitor management server 400, a first BLE AP 510, a second BLE AP 520, a third BLE AP 530, and an entry terminal device 600.

In an embodiment, the visitor management server 400 may be configured to perform operations or functions of the entry security server 100 and the entry control server 300, and the entry security server 100 and the entry control server 300 may be omitted. In another embodiment, the entry security server 100 may be configured to perform the operation or function of the entry control server 300, and the entry control server 300 may be omitted.

In addition, the entry management system may further include a plurality of BLE APs including the first BLE AP 510, the second BLE AP 520, and the third BLE AP 530. In the drawings, three BLE APs are illustrated merely for convenience of description.

The entry terminal device 600, the visitor management server 400, the first BLE AP 510, the second BLE AP 520, and the third BLE AP 530 may communicate through BLE which is a short-range communication technology. At least one of the first BLE AP 510, the second BLE AP 520, and the third BLE AP 530 may transmit a beacon signal received from the entry terminal device 600 to the visitor management server 400, and may transmit a control signal received from the visitor management server 400 to the entry terminal device 600.

The entry security server 100, the entry control server 300, the entry terminal issuing apparatus 200, and the visitor management server 400 may communicate through a wired or wireless communication network. The wired or wireless communication network may include a communication network for performing wireless Internet communication such as Wireless LAN (WLAN), Wireless Broadband (WiBro), Wi-Fi, World Interoperability for Microwave Access (WiMax), High Speed Downlink Packet Access (HSDPA), 3G communication functions, 4G such as Long Term Evolution (LTE) communication functions, 5G communication functions, etc.

First, an operation of issuing an entry terminal device 600 to a visitor and activating the entry terminal device 600 to be usable is described.

A visitor or a person concerned at the site visited by the visitor may access the entry security server 100 through a personal terminal 10 and may input the entry information of the visitor and information of the person concerned. The personal terminal 10 may be an electronic device capable of performing communication in a wired or wireless manner, such as a smart phone, a desktop computer, or a laptop computer.

The entry security server 100 may store the entry information of the visitor and information of the person concerned, and may manage reservation of the visitor. The entry information of the visitor may include at least one of a name, company name, contact information, face photo, and date and time of the visitor's visit, and an authorized area where the visitor is permitted to visit. The information of the person concerned may include at least one of a name, contact information, and/or a department name of the person that the visitor will visit.

The entry terminal issuing apparatus 200 is provided at the site where a visitor will visit. The entry terminal issuing apparatus 200 may issue the entry terminal device 600 by the request of the visitor. The entry terminal issuing apparatus 200 may be, for example, a kiosk or a computer managed by an administrator.

In detail, the visitor may input identification information of the visitor by operating an operation panel provided on the entry terminal issuing apparatus 200, and then may request the issuance of the entry terminal device 600. When a request for issuance by a visitor is input, the entry terminal issuing apparatus 200 may photograph a face of the visitor to generate a facial image and issue the entry terminal device 600.

When the visitor tags the entry terminal device 600 to a reader (not shown) provided in the entry terminal issuing apparatus 200, the entry terminal issuing apparatus 200 may map and store the generated facial image, may obtain (e.g., input) identification information of the visitor and identification information of the issued entry terminal device 600, and may then transmit the image and information to the entry security server 100.

The identification information of the visitor may be, for example, a name and contact information of the visitor.

The identification information of the entry terminal device 600 may include at least one of an identification number (e.g., a near field communication (NFC) number) of an NFC module embedded in the entry terminal device 600 and/or a media access control (MAC) address of a BLE beacon.

The entry security server 100 may generate entry mapping information by mapping the identification information of the entry terminal device 600 on the entry information and facial image of the visitor registered in advance based on the identification information of the visitor received from the entry terminal issuing apparatus 200. As an example, the entry security server 100 may search for the entry information of the visitor stored in advance from a database (not shown) of the entry security server 100 using the received identification information of the visitor, and may generate information (hereinafter referred to as “entry mapping information”) obtained by mapping the retrieved entry information of the visitor, the identification information of the entry terminal device 600, and the facial image.

The entry security server 100 may transmit the generated entry mapping information to the entry control server 300 and the visitor management server 400.

The entry control server 300 may store the entry mapping information received from the entry security server 100 and transmit the entry mapping information to the visitor management server 400. In addition, the entry control server 300 may check whether a visitor (i.e., an entry terminal device 600) passing through a gate is a pre-registered visitor and open or block the gate to manage the entry of the visitor.

The visitor management server 400 may manage a location of the entry terminal device 600 based on a beacon signal received from at least one of the first BLE AP 510, the second BLE AP 520, and the third BLE AP 530, and the stored entry mapping information.

In addition, the visitor management server 400 may store the entry mapping information of the visitor received from the entry security server 100 or the entry control server 300, and may map information indicating that the entry terminal device 600 is in an inactive state on identification information of the entry terminal device 600 and store the information.

As an example, when a signal (e.g., a beacon signal) transmitted from the entry terminal device 600 is received through the first BLE AP 510, the visitor management server 400 may check that the entry terminal device 600 is in an inactive state by using information mapped on the identification information of the entry terminal device 600 included in the received signal. The visitor management server 400 may request the first BLE AP 510 to perform pairing with the entry terminal device 600 in order to switch the state of the entry terminal device 600 to an active state.

When pairing is performed on the first BLE AP 510 and the entry terminal device 600, the first BLE AP 510 reports the pairing to the visitor management server 400. When the pairing is performed on the first BLE AP 510 and the entry terminal device 600, the visitor management server 400 may transmit the entry information and facial image of the visitor to the entry terminal device 600 through the paired first BLE AP 510. In an example, the visitor management server 400 may adjust the resolution and size of the entry information and facial image of the visitor in consideration of a size of an e-paper panel 630 of the entry terminal device 600 and then transmit the entry information and facial image of the visitor.

In addition, when the pairing is performed on the first BLE AP 510 and the entry terminal device 600, the visitor management server 400 may further transmit a plurality of pieces of background data to be displayed on the entry terminal device 600, before the entry terminal device 600 is activated. For example, the visitor management server 400 may further transmit the plurality of pieces of background data together with the entry information and facial image of the visitor to the entry terminal device 600.

The plurality of pieces of background data may include background information or background images displayed in different colors depending on a state mode of the entry terminal device 600, which may allow a state of the entry terminal device 600 to be visually identified. The state mode may include, for example, a basic mode in which the entry terminal device 600 is located in an authorized area, a warning mode in which the entry terminal device 600 is located in an unauthorized area, and an emergency mode in which the visitor is in a dangerous situation. The warning mode may be, for example, a mode indicating a state in which the entry terminal device 600 has entered the unauthorized area. The emergency mode may be, for example, a mode indicating a state in which an emergency signal is transmitted from the entry terminal device 600.

In this way, transmitting background data together with the entry information in an initial activation stage (or before being activated) may minimize the delay time because, after the entry terminal device 600 becomes an active state where the entry terminal device 600 is usable, when the background data is transmitted to the entry terminal device 600 and the mode of the entry terminal device 600 is switched to the warning mode, it takes more time to transmit the background data, which causes more delay time in changing the background color.

Hereinafter, an embodiment of transmitting a plurality of pieces of background data together with entry information of a visitor is described. However, the present disclosure is not limited thereto. For example, in another embodiment, the plurality of pieces of background data may be transmitted each time the state of the entry terminal device 600 is switched.

Pairing is performed on the first BLE AP 510 and the entry terminal device 600 by the request of the visitor management server 400, and the entry information and facial image of the visitor and the plurality of pieces of background data may be transmitted to the entry terminal device 600. Indexes of different control signals may be mapped on the plurality of pieces of background data.

The entry terminal device 600 may store the entry information and facial image of the visitor and the plurality of pieces of background data received from the first BLE AP 510, may display the stored entry information and facial image of the visitor on the e-paper panel 630, and may switch the state thereof to an active state. In addition, the entry terminal device 600 may display a background color of the e-paper panel 630 using the background data corresponding to a basic mode (i.e., a normal state). Accordingly, the entry terminal device 600 may display a basic background color indicating that the entry terminal device 600 is in a normal state as the background color of the entry information and facial image of the visitor.

Thus, the state of the entry terminal device 600 is switched to the active state, and the visitor may enter the authorized area using the entry terminal device 600.

As an example, when the visitor tags the entry terminal device 600 to a reader 20 provided at the gate, the entry control server 300 may check the NFC number of the entry terminal device 600, may authenticate the entry of the visitor, and may open the gate.

The visitor who enters a building may wear the entry terminal device 600 so that security managers within the building may easily identify the visitor. When the visitor is located in a pre-authorized area, the entry terminal device 600 may display a basic background color on the e-paper panel 630, and thus the security manager may visually identify that the visitor is located in the authorized area.

In an embodiment, the first to third BLE APs 510 to 530 may be installed in various locations such as walls or ceilings within a building and may transmit and receive Bluetooth-based beacon signals to and from the entry terminal device 600. The first to third BLE APs 510 to 530 receive beacon signals broadcasted from the entry terminal device 600 and transmit the beacon signals to the visitor management server 400.

The visitor management server 400 may analyze at least one received beacon signal and may determine whether the visitor is located in an authorized area or an unauthorized area. The received beacon signal may include a MAC address of the entry terminal device 600 that broadcasted the beacon signal and identification information of at least one BLE AP that transmitted the beacon signal.

The visitor management server 400 may compare the MAC address of the received beacon signal with pre-stored entry mapping information to check the visitor who has the entry terminal device 600, and may determine the location of the entry terminal device 600 from the identification information of the BLE AP. The visitor management server 400 may compare the determined location with the authorized area set for the visitor in the entry mapping information to determine whether the visitor is located in the authorized area.

When it is determined that the visitor is located in the unauthorized area, the visitor management server 400 may request the second BLE AP 520 or a plurality of BLE APs including the second BLE AP 520 to transmit a first control signal for instructing a change in the background color to the entry terminal device 600. The second BLE AP 520 may be an AP that most recently communicated with the entry terminal device 600. The second BLE AP 520 may transmit the first control signal received from the visitor management server 400 to the entry terminal device 600.

The entry terminal device 600 that receives the first control signal may output a warning sound to the outside, and may change the background color of the e-paper panel 630 using background data preset in the first control signal. In this way, the entry terminal device 600 may change the background color more quickly by receiving and storing the background data in advance upon initial activation, and then receiving a control signal when a background color change is needed. In addition, the security manager may identify that the visitor is located in the unauthorized area from the background color or warning sound of the entry terminal device 600.

In addition, the visitor management server 400 may analyze the beacon signal broadcasted and received from the entry terminal device 600 and, when it is determined that the visitor has moved to an authorized area, the visitor management server 400 may generate a second control signal that instructs the entry terminal device 600 to change the background color, and may transmit the second control signal to the entry terminal device 600.

The entry terminal device 600 that receives the second control signal may stop outputting the warning sound and change the background color of the e-paper panel 630 to background data preset in the second control signal, i.e., a color indicating a normal state.

In addition, when an emergency signal is received from the entry terminal device 600, the visitor management server 400 may transmit a third control signal, that corresponds to the emergency signal, together with location information of the entry terminal device 600 to an administrator terminal (not shown) located near the entry terminal device 600. The emergency signal may be a signal for a visitor to request help, and may be transmitted when the visitor select an emergency button 660 provided on the entry terminal device 600.

The entry terminal device 600 may change the background color of the e-paper panel 630 using background data set in the received third control signal, and output a warning sound to the outside. In addition, the administrator who receives the location information and the third control signal through the administrator terminal (not shown) may recognize that the visitor is in an emergency situation, may move to the location of the entry terminal device 600, may check the visitor's condition, and may take action.

When an emergency release signal is generated, the entry terminal device 600 may broadcast a beacon signal including the emergency release signal. The emergency release signal may be generated when the visitor selects the emergency button 660 of the entry terminal device 600 for a set time or longer.

The visitor management server 400 analyzes the received beacon signal and, when it is determined that the emergency situation has been released, the visitor management server 400 may generate a fourth control signal that instructs the entry terminal device 600 to change the background color and transmit the fourth control signal to the entry terminal device 600.

The entry terminal device 600 that receives the fourth control signal may stop outputting the warning sound and change the background color of the e-paper panel 630 to background data preset in the fourth control signal, i.e., a color indicating a normal state.

In addition, when a front surface blocking signal is received from the entry terminal device 600, the visitor management server 400 may transmit a fifth control signal that requests the entry terminal device 600 to output a warning sound to the entry terminal device 600. The front surface blocking signal is a signal indicating that the front surface of the e-paper panel 630 of the entry terminal device 600 on which the entry information is displayed is covered.

When it is determined that the blocking state is released, the entry terminal device 600 may broadcast a beacon signal including a blocking release signal.

The visitor management server 400 may analyze the received beacon signal and, when it is determined that the blocking of the e-paper panel is released, the visitor management server 400 may generate a sixth control signal that instructs the entry terminal device 600 to change the background color and transmit the sixth control signal to the entry terminal device 600.

The entry terminal device 600 that receives the sixth control signal may stop outputting the warning sound and change the background color of the e-paper panel 630 to background data preset in the sixth control signal, i.e., a color indicating a normal state.

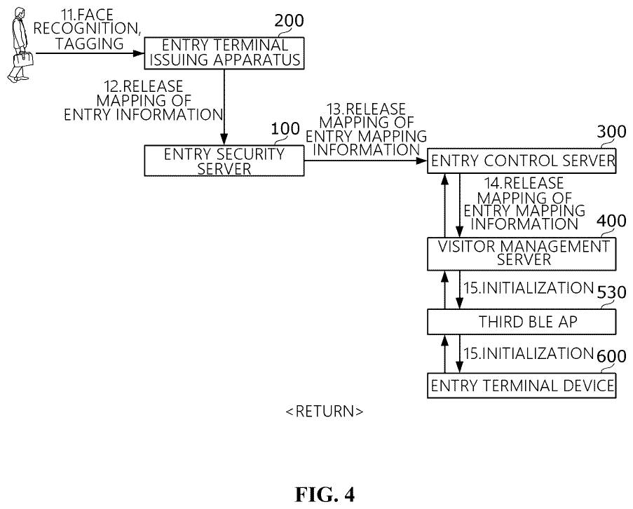

FIG. 4 is a diagram for describing a return operation in the operation of the entry management system, according to an embodiment of the present disclosure.

Referring to FIG. 4, in order to return the entry terminal device 600, the entry terminal issuing apparatus 200 may perform facial recognition on a visitor, tag the entry terminal device 600 to a reader (not shown) of the entry terminal issuing apparatus 200, and then return the entry terminal device 600.

The entry terminal issuing apparatus 200 may check the facial image that is identical to the currently recognized face among the plurality of facial images stored in advance, and may check identification information of the entry terminal device 600 stored by being mapped on the identified facial image. When identification information of the checked entry terminal device 600 is identical to the identification information of the returned entry terminal device 600, the entry terminal issuing apparatus 200 may determine that the return has been completed normally.

When the return of the entry terminal device 600 is confirmed, the entry terminal issuing apparatus 200 may transmit the identification information of the visitor or the identification information of the entry terminal device 600 to the entry security server 100, and may request the entry security server 100 to release mapping of the entry information previously performed.

The entry security server 100 may release the mapping of the entry mapping information generated for the visitor, and may also request the entry control server 300 and the visitor management server 400 to release the mapping of the entry mapping information.

The entry control server 300 and the visitor management server 400 may thus release the mapping of the entry mapping information generated for the visitor.

The visitor management server 400 may transmit a seventh control signal that instructs the entry terminal device 600 to be initialized through the third BLE AP 530, for example.

The entry terminal device 600 may delete the entry information stored in the entry terminal device 600 based on the received seventh control signal, may be initialized, and may then switch the state thereof to an inactive state. Accordingly, the return procedure of the entry terminal device 600 may be completed.

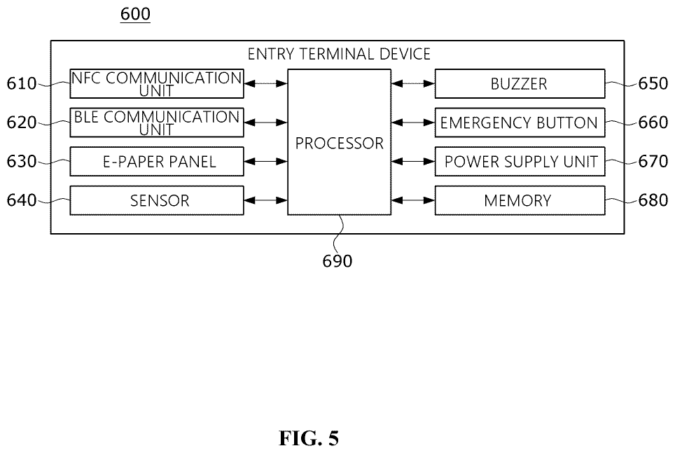

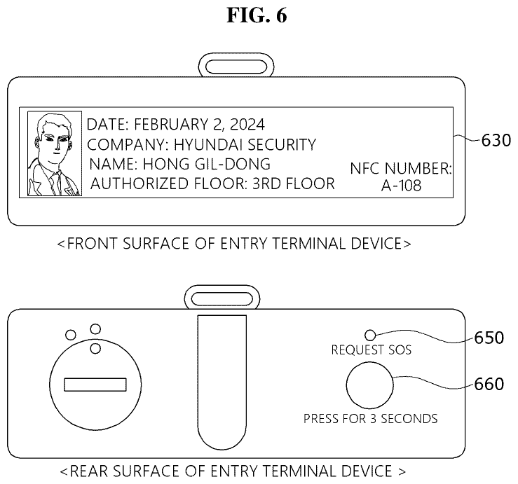

FIG. 5 is a block diagram illustrating the entry terminal device 600, according to an embodiment of the present disclosure. FIG. 6 is a diagram showing the front and rear surfaces of the entry terminal device 600, according to an embodiment of the present disclosure.

Referring to FIGS. 5 and 6, the entry terminal device 600 according to an embodiment of the present disclosure may include an NFC communication unit 610, a BLE communication unit 620, an e-paper panel 630, a sensor 640, a buzzer 650, an emergency button 660, a power supply unit 670, a memory 680, and a processor 690.

The NFC communication unit 610 may include an NFC antenna and a communication circuit that communicates with the NFC reader 20 of the gate. The NFC communication unit 610 may have a card or chip form for being tagged to the NFC reader 20.

The BLE communication unit 620 may include a BLE antenna and a communication circuit for transmitting and receiving beacon signals to and from the first to third BLE APs 510 to 530. For example, the BLE communication unit 620 may pair with at least one of the first to third BLE APs 510 to 530. The BLE communication unit 620 may broadcast a beacon signal, and may receive a facial image and identification information of the visitor, a plurality of pieces of background data, and a plurality of control signals from the visitor management server 400.

The e-paper panel 630 may display the facial image and entry information of the visitor, and may display a background color related to a state mode of the entry terminal device 600 on the front surface thereof. The e-paper panel 630 may include a display unit (not shown) and a driver (not shown) that drives the display unit (not shown). The display unit (not shown) may be provided on the front surface of the e-paper panel 630, and the buzzer 650 and the emergency button 660 described below may be provided on the rear surface thereof. However, this is only an example and the present disclosure is not limited thereto.

The sensor 640 may transmit an infrared signal to calculate a distance between an object and the front surface of the e-paper panel 630 on which the entry information is displayed. The object faces the front surface of the e-paper panel 630. The sensor 640 may be provided on the front surface of the e-paper panel 630.

The buzzer 650 may output a warning sound under the control of the visitor management server 400 or output the warning sound at the request of the visitor.

The emergency button 660 may generate an emergency signal when a visitor touches or presses it.

The power supply unit 670 may supply power to the entry terminal device 600 and may include, for example, a rechargeable battery and a step-up converter.

At least one memory 680 may store at least one program (e.g., a plurality of software, firmware, middleware, etc.), various data (e.g., an NFC number), and at least one instruction for controlling the entry terminal device 600. The memory 680 may be used to load a program, read or write data, or perform an operation corresponding to an instruction at the request of at least one processor 690. The memory 680 may include a volatile memory and a nonvolatile memory.

In addition, the memory 680 may further store the facial image and entry information of the visitor received from the visitor management server 400 and a plurality of pieces of background data on which control signal indexes are mapped.

The processor 690 may perform comprehensive control of the entry terminal device 600 according to an input instruction. The instruction may be input to the processor 690 by using the memory 680 or by the BLE communication unit 620. As an example, the processor 690 may execute a program or instructions stored in the memory 680 to control an operation of a component (hardware or software) connected to the processor 690 and process data. The processor 690 may include at least one of, for example, at least one central processing unit, at least one microprocessor, and/or at least one digital signal processor (DSP). In addition, the processor 690 may load an instruction or data received from other components (e.g., the NFC communication unit 610 and the BLE communication unit 620) into a volatile memory, may process the instructions or data stored in the volatile memory, and may store the processing result in the nonvolatile memory.

As an example, the processor 690 may control the BLE communication unit 620 to perform pairing with the first BLE AP 510 according to a pairing instruction received from the visitor management server 400 through the first BLE AP 510. When the pairing is performed on the BLE communication unit 620 and the first BLE AP 510, the processor 690 may store the facial image and entry information of the visitor and a plurality of pieces of background data received from the visitor management server 400 in the memory 680. The processor 690 may then switch a state of the entry terminal device 600 to an active state. In addition, the processor 690 may control the e-paper panel 630 to display the facial image and entry information as shown in FIG. 6 using the background data corresponding to a basic mode (i.e., a normal state) among the plurality of pieces of background data as a background color. The processor 690 may also control the e-paper panel 630 to further display an NFC number assigned to the NFC communication unit 610.

When the entry terminal device 600 is activated, the visitor may enter the gate and tag the entry terminal device 600 to the NFC reader 20. The NFC communication unit 610 may communicate with the NFC reader 20 through tagging to perform visitor authentication, and the visitor may pass through the gate.

The processor 690 may control the BLE communication unit 620 to generate a beacon signal including identification information of the entry terminal device 600 (e.g., the MAC address of the BLE communication unit 620) and then broadcast the beacon signal. The broadcasted beacon signal may be transmitted to the visitor management server 400 through at least one of the first to third BLE APs 510 to 530. The broadcasted beacon signal may be used to identify the location of the entry terminal device 600.

In addition, when the first control signal is received from the visitor management server 400, the processor 690 may control the buzzer 650 to output a warning sound to the outside, to check the background data mapped on the first control signal, and to transmit the checked background data to the e-paper panel 630 to instruct the e-paper panel 630 to change the background color. The first control signal is, for example, a signal generated when the visitor, i.e., the entry terminal device 600, is located in the unauthorized area.

Therefore, the processor 690 may change the background color of the e-paper panel 630 using the background data preset in the first control signal. In this way, since the entry terminal device 600 has received and stored the plurality of pieces of background data in advance upon initial activation, when the entry terminal device 600 receives a control signal when a background color change is required later, the entry terminal device 600 may change the background color more quickly by using the background data to which the index of the control signal is mapped among the plurality of pieces of background data stored previously. In addition, other people, such as the security manager or the like, may visually identify that the visitor is located in the unauthorized area from the background color of the entry terminal device 600. In addition, when the emergency button 660 is selected by the visitor more than a set number of times (e.g., n times) within a set time (e.g., m seconds) or is continuously selected for a set time, the processor 690 may control the BLE communication unit 620 to broadcast an emergency signal generated from the emergency button 660 and may also control the buzzer 650 to output the warning sound.

The visitor management server 400 that receives the emergency signal may transmit a third control signal together with the location information of the entry terminal device 600 and an administrator terminal (not shown) close to the entry terminal device 600. Upon receiving the third control signal, the processor 690 may check the background data mapped on the index of the third control signal, and may control the e-paper panel 630 to change the background color to a color corresponding to the checked background data. In this way, the administrator may quickly identify the visitor who has requested help from the background color of the e-paper panel 630.

In addition, the processor 690 may determine whether the front surface of the e-paper panel 630 is in a blocking state, i.e., whether the front surface is in contact with the object and the front surface is covered, based on the distance to the object calculated by the sensor 640. As an example, when the distance to the object calculated by the sensor 640 is less than or equal to a threshold value, the processor 690 may determine that the front surface is blocked. The processor 690 may control the BLE communication unit 620 to transmit the result of determining that the front surface of the e-paper panel 630 is in the blocking state to the visitor management server 400. Accordingly, the visitor management server 400 outputs a warning sound and transmits the third control signal that causes a guidance message to be displayed to the BLE communication unit 620. The guidance message is a message that guides the visitor to change a direction of the e-paper panel 630. The guidance message may also be transmitted in advance at the initial active state stage together with a plurality of pieces of background data.

The processor 690 may output the warning sound through the buzzer 650 based on the received third control signal and display a guidance message on the e-paper panel 630.

In addition, when the fifth control signal that instructs initialization of the entry terminal device 600 is received from the visitor management server 400, the processor 690 may delete the facial image and entry information stored in the memory 680, initialize the entry terminal device 600, and then switch the state of the entry terminal device 600 to an inactive state.

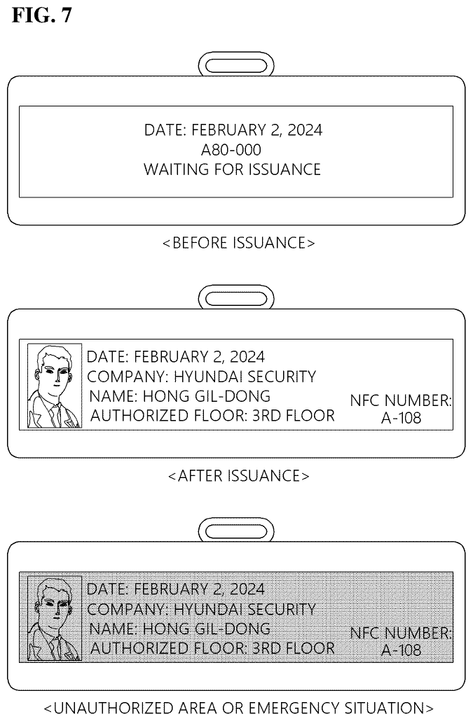

FIG. 7 is a diagram showing a background color related to a state of the entry terminal device 600, according to an embodiment of the present disclosure.

Referring to FIG. 7, before the entry terminal device 600 is activated or issued, the e-paper panel 630 displays a message saying “waiting for issuance.” When the entry terminal device 600 is issued and activated, the entry terminal device 600 may display a facial image and entry information of a visitor, and may display a background color corresponding to a basic mode. When the entry terminal device 600 is located in an unauthorized area or the visitor is in an emergency situation, the entry terminal device 600 may change the background color of the e-paper panel 630 to a background color corresponding to a warning mode.

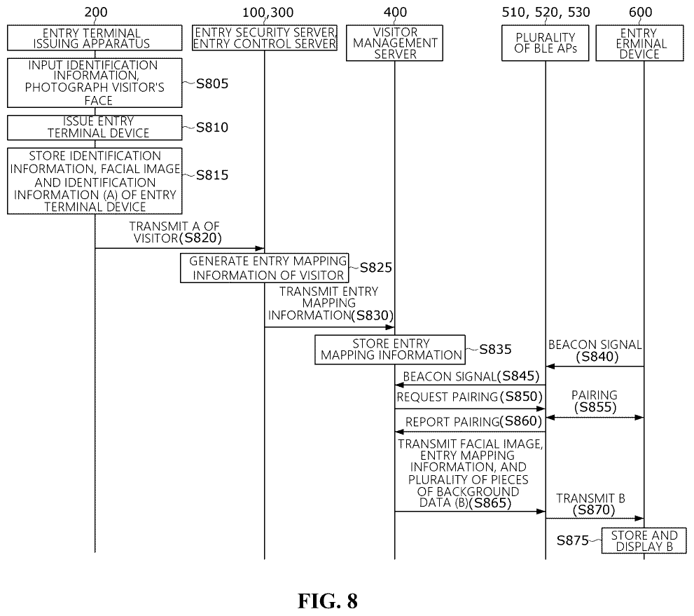

FIG. 8 is a flowchart illustrating a method of issuing an entry terminal device 600 in an entry management method for visitor management, according to an embodiment of the present disclosure.

Referring to FIG. 8, when a visitor inputs his or her identification information in the entry terminal issuing apparatus 200 and then requests issuance of an entry terminal device 600, the entry terminal issuing apparatus 200 may photograph a face of the visitor to generate a facial image and issue the entry terminal device 600 in operations S805 and S810.

When the visitor tags the entry terminal device 600 to the entry terminal issuing apparatus 200, the entry terminal issuing apparatus 200 may store the facial image and identification information of the visitor and identification information of the issued entry terminal device 600 in an operation S815. The entry terminal issuing apparatus 200 may then transmit the facial image and identification information and the identification information to the entry security server 100 in an operation S820.

In an operation S825, the entry security server 100 and the entry control server 300 may generate and store entry mapping information by mapping the identification information of the entry terminal device 600 and entry information and facial image of the visitor registered in advance based on the received identification information of the visitor.

In an operation S830, the entry security server 100 or the entry control server 300 may transmit the generated entry mapping information to the visitor management server 400.

The visitor management server 400 may store the visitor entry mapping information received from the operation S830.

In an operation S840, the entry terminal device 600 issued in operation S810 broadcasts a beacon signal requesting activation thereof. In an operation S845, the first BLE AP 510 that receives the beacon signal transmits the beacon signal to the visitor management server 400.

In an operation S850, the visitor management server 400 that receives the beacon signal may request the first BLE AP 510 to perform pairing with the entry terminal device 600.

When the pairing is performed on the first BLE AP 510 and the entry terminal device 600 in an operation S855, the first BLE AP 510 reports the pairing to the visitor management server 400 in an operation S860.

The visitor management server 400 may transmit the entry information and facial image of the visitor and a plurality of pieces of background data to the entry terminal device 600 through the paired first BLE AP 510 in operations S865 and S870.

In an operation S875, the entry terminal device 600 may store the entry information and facial image of the visitor and the plurality of pieces of background data received from the first BLE AP 510, may display the stored entry information and facial image of the visitor and a background page corresponding to the basic mode on the e-paper panel 630, and may switch a state thereof to an active state. Thus, the state of the entry terminal device 600 is switched to the active state, and the visitor may enter an authorized area using the entry terminal device 600.

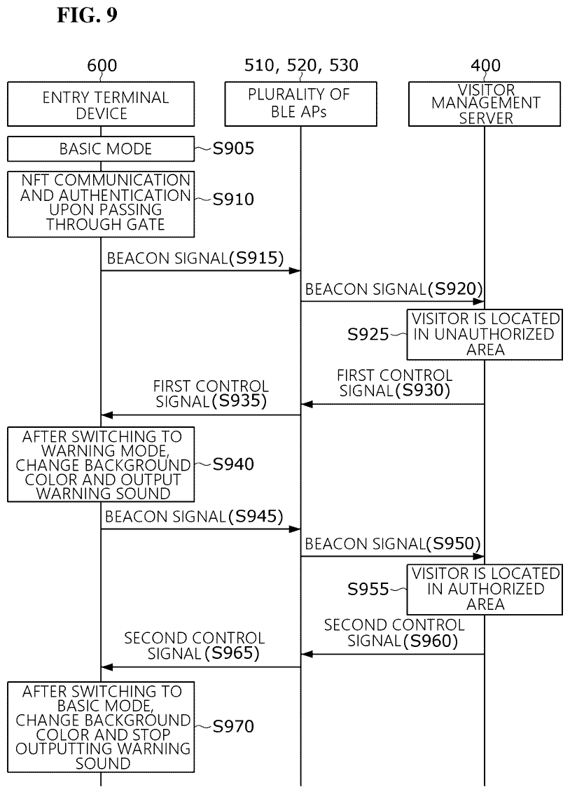

FIG. 9 is a flowchart illustrating an entry management method for visitor management when the entry terminal device 600 is located in an unauthorized area in the entry management method for visitor management, according to an embodiment of the present disclosure.

Referring to FIG. 9, when the entry terminal device 600 is tagged to the NFC reader 20 to pass through the gate while the entry terminal device 600 is in the basic mode, the entry terminal device 600 performs visitor authentication with the NFC reader 20 in operations S905 and S910.

When visitor authentication is completed and the visitor passes through the gate, the entry terminal device 600 broadcasts a beacon signal including a MAC address in an operation S915.

The second BLE AP 520 that receives the beacon signal broadcasted in the operation S915 transmits the beacon signal to the visitor management server 400 in an operation S920.

When the visitor management server 400 analyzes the received beacon signal and it is determined that the visitor is located in the unauthorized area in an operation S925, a first control signal that instructs the entry terminal device 600 to change the background color may be generated and transmitted to the second BLE AP 520 in an operation S930. In this case, when the entry terminal device 600 moves and communicates with another BLE AP, the visitor management server 400 may transmit the first control signal to the other BLE AP.

In an operation S935, the second BLE AP 520 transmits the received first control signal to the entry terminal device 600.

In an operation S940, the entry terminal device 600 that receives the first control signal may output a warning sound to the outside, and change the background color of the e-paper panel 630 to a color corresponding to the background data preset in the first control signal.

In an operation S945, the entry terminal device 600 periodically broadcasts a beacon signal. In an operation S950, the BLE AP (e.g., the second BLE AP 520) that receives the beacon signal transmits the received beacon signal to the visitor management server 400.

When the visitor management server 400 analyzes the received beacon signal and it is determined that the visitor has moved to an authorized area in an operation S955, a second control signal that instructs the entry terminal device 600 to change the background color may be generated and transmitted to the second BLE AP 520 in an operation S960.

The second BLE AP 520 transmits the received second control signal to the entry terminal device 600 in an operation S965.

The entry terminal device 600 that receives the second control signal may stop outputting the warning sound, and may change the background color of the e-paper panel 630 to the background data preset in the second control signal, i.e., a color indicating a normal state, in an operation S970.

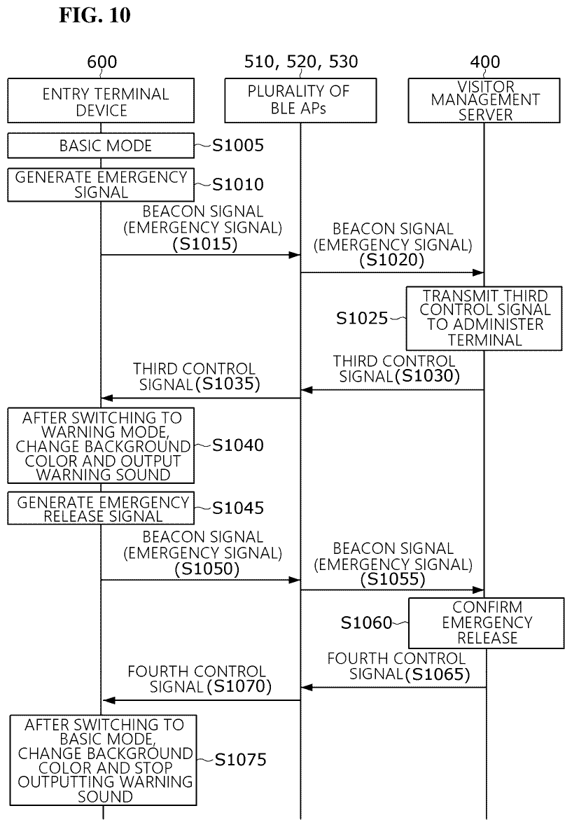

FIG. 10 is a flowchart for describing an entry management method for visitor management when the entry terminal device 600 is in an emergency situation in the access control method for visitor management, according to an embodiment of the present disclosure.

Referring to FIG. 10, when the emergency button 660 is selected and an emergency signal is generated while the entry terminal device 600 is in the basic mode in operations S1005 and S1010, the entry terminal device 600 broadcasts a beacon signal including the emergency signal in an operation S1015.

In an operation S1020, the second BLE AP 520 that receives the beacon signal broadcasted in the operation S1015 transmits the beacon signal to the visitor management server 400.

When the visitor management server 400 analyzes the received beacon signal and determines that the visitor of the entry terminal device 600 is in the emergency situation, a third control signal is transmitted to one or more administrator terminals close to the entry terminal device 600 in an operation S1025.

In addition, the visitor management server 400 may transmit a third control signal that instructs the entry terminal device 600 to change the background color to the second BLE AP 520 in an operation S1030.

In an operation 1035, the second BLE AP 520 transmits the received third control signal to the entry terminal device 600.

In an operation S1040, the entry terminal device 600 that receives the third control signal may output a warning sound to the outside, and change the background color of the e-paper panel 630 to a color corresponding to the background data preset in the third control signal.

When an emergency release signal is generated in an operation S1045, the entry terminal device 600 may broadcast a beacon signal including the emergency release signal in an operation S1050, and the second BLE AP 520 that receives the beacon signal transmits the beacon signal to the visitor management server 400 in an operation S1055.

When the visitor management server 400 analyzes the received beacon signal and determines that the emergency situation has been released in an operation S1060, a fourth control signal that instructs the entry terminal device 600 to change the background color may be generated and transmitted to the second BLE AP 520 in an operation S1065.

The second BLE AP 520 transmits the received fourth control signal to the entry terminal device 600 in an operation S1070.

The entry terminal device 600 that receives the fourth control signal may stop outputting the warning sound, and change the background color of the e-paper panel 630 to the background data set in the fourth control signal, i.e., a color indicating a normal state, in an operation S1075.

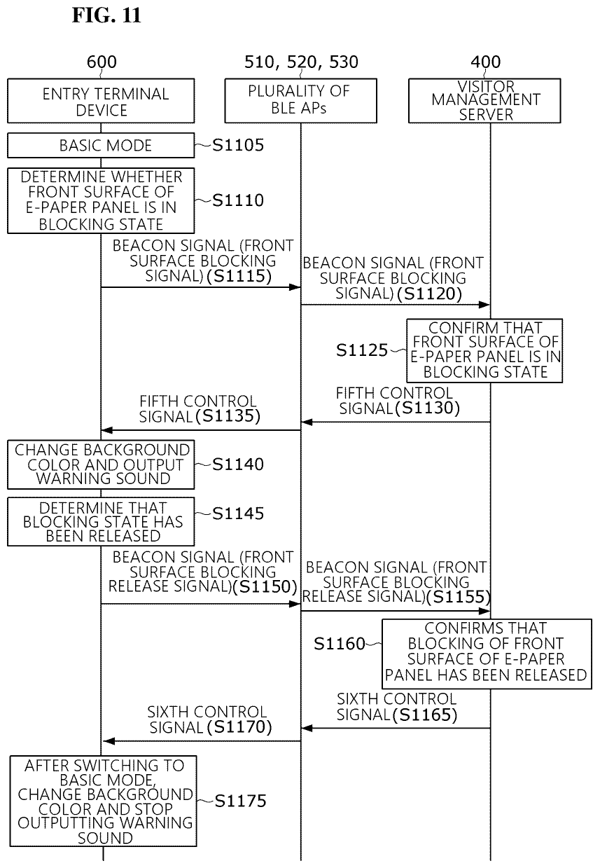

FIG. 11 is a flowchart for describing an entry management method for visitor management when the entry terminal device 600 is in a blocking state in the entry control method for visitor management, according to an embodiment of the present disclosure.

Referring to FIG. 11, when the entry terminal device 600 is in a basic mode, the entry terminal device 600 may determine whether the front surface of the e-paper panel 630 is in a blocking state using an infrared sensor thereof in operations S1105 and S1110.

When it is determined that the e-paper panel 630 is in the blocking state, the entry terminal device 600 broadcasts a beacon signal including a front surface blocking signal in an operation S1115.

The second BLE AP 520 that receives the beacon signal broadcasted in operation S1115 transmits the beacon signal to the visitor management server 400 in an operation S1120.

When the visitor management server 400 analyzes the received beacon signal and determines that the front surface of the entry terminal device 600 is in the blocked state in an operation S1125, a fifth control signal is transmitted to the second BLE AP 520 in an operation S1130.

In an operation S1135, the second BLE AP 520 transmits the received fifth control signal to the entry terminal device 600.

In an operation S1140, the entry terminal device 600 that receives the fifth control signal may output a warning sound to the outside and change the background color of the e-paper panel 630 to a color corresponding to the background data preset in the fifth control signal.

In an operation S1145, the entry terminal device 600 may determine whether the blocking state has been released using the infrared sensor. Since the sensor 640 periodically transmits an infrared signal, the entry terminal device 600 may periodically check whether the entry terminal device 600 is blocked.

When it is determined that the blocking state has been released, the entry terminal device 600 broadcasts a beacon signal including a blocking release signal in an operation S1150, and the second BLE AP 520 that receives the beacon signal transmits the beacon signal to the visitor management server 400 in an operation S1155.

When the visitor management server 400 analyzes the received beacon signal and determines that the blocking of the e-paper panel has been released in an operation S1160, a sixth control signal that instructs the entry terminal device 600 to change the background color may be generated and transmitted to the second BLE AP 520 in an operation S1165.

In an operation S1170, the second BLE AP 520 transmits the received sixth control signal to the entry terminal device 600.

The entry terminal device 600 that receives the sixth control signal may stop outputting a warning sound and change the background color of the e-paper panel 630 to the background data preset in the sixth control signal, i.e., a color indicating a normal state, in an operation S1175.

According to embodiments of the present disclosure, a location of an entry terminal device may be determined in real time, information of a visitor located in an unauthorized area may be checked in real time, and the state of the entry terminal device may be easily identified by other people using the background color of the entry terminal device.

In addition, according to embodiments of the present disclosure, by transmitting a plurality of pieces of background data together with entry information of a visitor in advance in initially activating an entry terminal device, a time required to change the background color of the e-paper panel when the visitor enters an unauthorized area or an emergency situation occurs may be minimized.

The effects of the present disclosure are not limited to those mentioned above. Other effects not mentioned herein may be more clearly understood by those having ordinary skill in the art from the description above.

Although methods of the present disclosure described above are expressed as a series of operations for clarity of description, this is not intended to limit the order in which steps are performed. In some embodiments, some steps may be performed simultaneously or in a different order. In order to implement the methods according to the present disclosure, other steps may be included in addition to the described steps, some described steps may be excluded and the remaining described steps may be included, or some described steps may be excluded and other additional steps may be included.

The various embodiments of the present disclosure do not list all possible combinations thereof, but describe representative aspects of the present disclosure. Matters described in connection with various embodiments may be applied independently or in a combination of two or more matters.

In addition, various embodiments of the present disclosure may be implemented by hardware, firmware, software, or a combination thereof. In the case of implementation by hardware, various embodiments of the present disclosure may be implemented by one or more ASICs, digital signal processors (DSPs), digital signal processing devices (DSPDs), programmable logic devices (PLDs), FPGAs, general processors, controllers, microcontrollers, microprocessors, etc.

The scope of the present disclosure includes software or machine-executable instructions (e.g., an operating system, an application, firmware, a program, etc.) that cause operations according to methods of various embodiments to be executed on a device or computer, and a non-transitory computer-readable medium in which such software or machine-executable instructions, etc. are stored and may be executed on a device or computer.

What is claimed is:

1. An entry terminal device for entry management of a visitor, the entry terminal device comprising:
an e-paper panel configured to display entry information of the visitor;
a Bluetooth low energy (BLE) communication unit configured to transmit and receives beacon signals to and from a plurality of BLE access points (BLE APs);
at least one processor; and
at least one memory that stores at least one program to be executed by the at least one processor,
wherein the at least one processor is configured to process the entry information received from a visitor management server through a first BLE AP among the plurality of BLE APs to be displayed on the e-paper panel.

2. The entry terminal device of claim 1, wherein the visitor management server is configured to:
request the first BLE AP to perform pairing with the BLE communication unit; and
when the pairing is performed, transmit the entry information to the BLE communication unit through the paired first BLE AP.

3. The entry terminal device of claim 2, wherein the processor is configured to:
process the entry information received from the visitor management server through the paired first BLE AP to be displayed on the e-paper panel; and
cause a background color corresponding to a basic mode to be displayed on the e-paper panel.

4. The entry terminal device of claim 3, wherein:
the visitor management server is configured to, when the entry terminal device is located in an unauthorized area or an emergency signal is received from the BLE communication unit, transmit a control signal for instructing a change in the background color; and
the processor is configured to cause the background color of the e-paper panel to be changed to a color preset in the received control signal such that the color is identifiable by another person.

5. The entry terminal device of claim 2, wherein the visitor management server is configured to, when the pairing is performed, transmit a plurality of pieces of background data to be displayed on the entry terminal device together with the entry information to the entry terminal device, wherein the plurality of pieces of background data include a background color set differently for each control signal transmitted from the visitor management server.

6. The entry terminal device of claim 1, further comprising a sensor configured to transmit an infrared signal to calculate a distance between an object and a front surface of the e-paper panel on which the entry information is displayed,
wherein the processor is configured to determine whether the front surface is in a blocking state using the calculated distance, and control the BLE communication unit to transmit a result of the determination to the visitor management server when the front surface is in the blocking state, and
wherein the visitor management server is configured to, when the result of the determination is received, transmit a control signal for outputting a warning sound to the BLE communication unit.

7. The entry terminal device of claim 1, wherein:
the plurality of BLE APs is configured to transmit beacon signals received from the BLE communication unit to the visitor management server; and
the visitor management server is configured to manage a location of the entry terminal device based on a beacon signal received through at least one of the plurality of BLE APs and pre-stored entry mapping information, and
wherein the pre-stored entry mapping information is information in which identification information of the entry terminal device and the entry information of the visitor registered in advance are mapped based on identification information of the visitor input by the visitor when the entry terminal device is received.

8. The entry terminal device of claim 7, wherein:
the identification information of the entry terminal device includes at least one of a media access control (MAC) address included in a beacon signal or an identification number of a near field communication (NFC) module included in the entry terminal device; and
the entry information includes i) at least one of a name, a company name, a face photo, or a date and time of visit of the visitor and ii) an authorized area where the visitor is permitted to visit.

9. The entry terminal device of claim 1, further comprising a near field communication (NFC) unit configured to perform entry authentication through NFC communication.

10. The entry terminal device of claim 1, wherein the e-paper panel is configured to further display a facial image of the visitor, wherein the facial image of the visitor is generated by an entry terminal issuing apparatus that issues the entry terminal device.

11. An entry management system comprising:
an entry terminal device;
an entry terminal issuing apparatus configured to issue the entry terminal device to a visitor when identification information of the visitor is input;
a visitor management server configured to store entry mapping information in which identification information of the entry terminal device and entry information of the visitor registered in advance are mapped based on the identification information of the visitor; and
a plurality of Bluetooth low energy access points (BLE APs) configured to communicate with the entry terminal device and the visitor management server,
wherein the entry terminal device is configured to display the entry information of the visitor received from the visitor management server through a first BLE AP among the plurality of BLE APs on an e-paper panel.

12. The entry management system of claim 11, wherein the visitor management server is configured to request the first BLE AP to perform pairing with the entry terminal device, and wherein, when the pairing is performed on the first BLE AP and the entry terminal device, the entry information of the visitor is transmitted to the entry terminal device through the paired first BLE AP.

13. The entry management system of claim 12, wherein the entry terminal device is configured to:
display the entry information received from the visitor management server through the paired first BLE AP on the e-paper panel; and
display a background color corresponding to a basic mode on the e-paper panel.

14. The entry management system of claim 13, wherein:
the visitor management server is configure to transmit a control signal for instructing a change in the background color when the entry terminal device is located in an unauthorized area or an emergency signal is received from the entry terminal device; and
the entry terminal device is configured to process the background color of the e-paper panel to be changed to a color preset in the received control signal such that the color is identifiable by another person.

15. The entry management system of claim 12, wherein the visitor management server is configured to, when the pairing is performed, transmit a plurality of pieces of background data to be displayed on the entry terminal device together with the entry information to the entry terminal device, wherein the plurality of pieces of background data include a background color set differently for each control signal transmitted from the visitor management server to guide a state of the entry terminal device.

16. The entry management system of claim 11, wherein:
the entry terminal device is configured to, when it is determined that a front surface of the e-paper panel on which the entry information is displayed is in a blocking state, process a result of the determination to be transmitted to the visitor management server through at least one of the plurality of BLE APs; and
the visitor management server is configured to, when the result of the determination is received, transmit a control signal for outputting a warning sound to the entry terminal device.

17. The entry management system of claim 11, wherein:
the plurality of BLE APs is configured to transmit beacon signals received from the entry terminal device to the visitor management server; and
the visitor management server is configured to manage a location of the entry terminal device based on beacon signals received from the plurality of BLE APs and the stored entry mapping information.

18. The entry management system of claim 11, wherein the entry terminal issuing apparatus is configured to photograph a face of the visitor to generate a facial image and issue the entry terminal device, wherein the generated facial image is transmitted to the entry terminal device and displayed on the e-paper panel.

19. The entry management system of claim 11, wherein the entry terminal device is configured to perform entry authentication through near field communication (NFC) communication.

20. The entry management system of claim 11, wherein:
the identification information of the entry terminal device includes at least one of a MAC address included in a beacon signal or an identification number of an NFC module included in the entry terminal device; and
the entry information includes i) at least one of a name, a company name, a face photo, or a date and time of visit of the visitor and ii) an authorized area where the visitor is permitted to visit.

21. An entry management method comprising:
issuing, by an entry terminal issuing apparatus, an entry terminal device to a visitor when identification information of the visitor is input;
storing, by a visitor management server, entry mapping information in which identification information of the entry terminal device and entry information of the visitor registered in advance are mapped based on the identification information of the visitor; and
displaying, by the entry terminal device, the entry information of the visitor received from the visitor management server through a first Bluetooth low energy access point (BLE AP) among a plurality of BLE APs on an e-paper panel,
wherein the plurality of BLE APs communicate with the entry terminal device and the visitor management server.

22. The entry management method of claim 21, wherein displaying the entry information of the visitor on the e-paper panel includes:
displaying the entry information received from the visitor management server through a paired first BLE AP among the plurality of BLE APs on the e-paper panel; and
displaying a background color corresponding to a basic mode on the e-paper panel.

23. The entry management method of claim 22, further comprising:
when the entry terminal device is located in an unauthorized area or an emergency signal is received from the entry terminal device, transmitting, by the visitor management server, a control signal for instructing a change in the background color; and
controlling, by the entry terminal device, the background color of the e-paper panel to be changed to a color preset in the received control signal such that the color is identifiable by another person.

24. The entry management method of claim 22, further comprising transmitting, by the visitor management server, a plurality of pieces of background data to be displayed on the entry terminal device together with the entry information to the entry terminal device through the paired first BLE AP, wherein the plurality of pieces of background data include a background color set differently for each control signal transmitted from the visitor management server to guide a state of the entry terminal device.
